(19) United States
(12) Patent Application Publication
(10) Pub. No.: US 2005/0066569 A1
(43) Pub. Date: Mar. 31, 2005

(54) Night fishman a rod reel holder

(76) Inventors: Glen Richard Bruner, Theodosia, MO (US); Daniel John Gross, St. Joseph, MO (US)

Correspondence Address: Glen Bruner;Apt # 207, 416 Delware St, Winchester, KS, 66097, US

(21) Appl. No.: 10/735,396

(22) Filed: Oct. 18, 2004

Related U.S. Application Data
(60) Provisional application No. 60/432,171, filed on Jan. 21, 2003.

(51) Int. Cl. A01K 97/12

(52) U.S. Cl. 43/17

(57) ABSTRACT

Night Fishman, is a rod and reel holder, designed for all fisherman including handicapped. It features a light and buzzer, powered by a 9 volt; battery that is activated, when fish comes in contact. The light feature, makes it possible to acknowledge fish on line, without all the extra night lights, that attract pesty insects, also helps the hearing impaired to acknowledge action. The buzzer feature helps to attract your attention, to activity on line, also helps the visually impaired. Night fishman can be constructed, in various sizes, to accommodate any type of fishing, and can be equipped with mounting bracket which can adapt to boats, piers, docks, ect. night fishman, has sturdy handle, to easily anchor into ground.

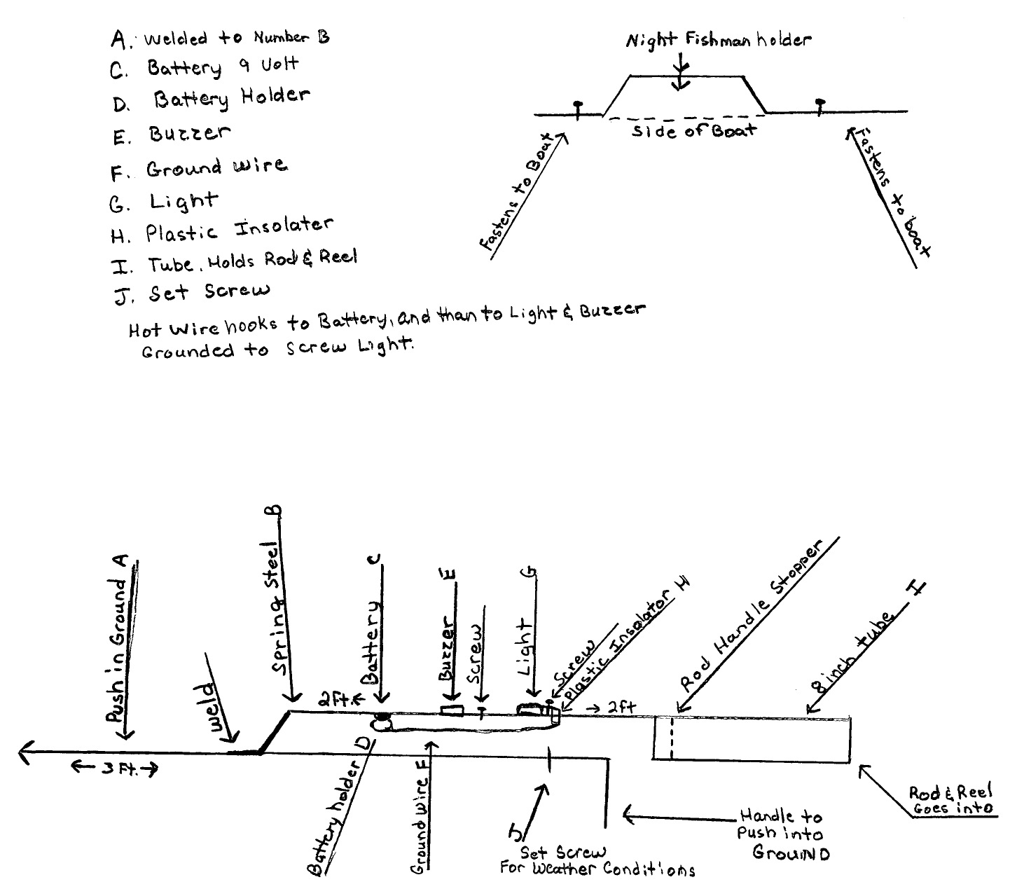

1. This is a rod and reel holder, that is constructed out of 7116 inch steel, It is 3 ft. long, and is 1¾ inch wide.

2. This Rod and Reel holder has a 2 inch piece of pipe on one end, that Rod and reel is inserted into.

3. On the other end of this rod and reel holder, there is a long piece of steel, that is spiked for easy insertion into the ground, this is what holds the Night Fishman in place, While you are fishing.

4. On top of the Night Fishman Rod and Reel holder is a 12 volt running light, and a buzzer, these are both mounted to steel, and are powered by a 9 volt battery.

5. The 9 volt battery sits in a holder, that locks battery into place. This holder is mounted on the underneath side of Night fishman, and sits under light and buzzer.

6. This Rod and Reel holder has 2 wires, one wire connects to the ground on the battery holder, and the other wire which is the hot wire, connects to a bolt that goes through a plastic bushing, So it will make contact with another bolt, when fish bite, this makes light and buzzer react, and alerts you to check line.

1. Night Fishman is a rod & reel holder, land or boat, built to last, made out of steel or plastic.

2. Night Fishman is a rod & reel holder, and has adjustable set screw to adjust to any weather or water conditions.

3. Night Fishman is a rod & reel holder and has a light mounted on. Lights up when fish make contact. Can also be used for the hearing impaired.

4. Night Fishman is a rod & reel holder, and has a buzzer mounted on. Buzzer sounds off when fish makes contact. Can also be used for the visually impaired.

5. Night Fishman is a rod & reel holder and is designed to help with bug control. Light & buzzer does the work for you. No extra light is needed to monitor your rod & reel.

6. Night Fishman is a rod & reel holder. The light & buzzer that is mounted on runs on a 9 volt battery.

7. Night Fishman is a rod & reel holder and can be constructed in various sizes to accommodate fresh water or salt water fishing.

8. Night Fishman is a rod & reel holder. The boat bracket is designed to stay stationary with screws or portable with C clamps.
